(19) United States
(12) Patent Application Publication
(10) Pub. No.: US 2024/0181757 A1
(43) Pub. Date: Jun. 6, 2024

(54) DIRECTIONAL TEAR PACKAGING FILM

(71) Applicant: AMCOR FLEXIBLES NORTH AMERICA, INC., Neenah, WI (US)

(72) Inventors: Tyler J. THEOBALD, Neenah, WI (US); Frank E. SECKAR, Oshkosh, WI (US)

(21) Appl. No.: 18/285,535

(22) PCT Filed: Apr. 8, 2021
(86) PCT No.: PCT/US2021/026469

§ 371 Date: Oct. 4, 2023

(51) Int. Cl. B32B 27/08; B32B 27/30; B32B 27/32; B32B 27/34; B65D 65/40

(52) U.S. Cl. CPC B32B 27/08; B32B 27/306; B32B 27/32; B32B 27/34; B65D 65/40; B32B 2250/24; B32B 2270/00; B32B 2307/31; B32B 2307/518; B32B 2307/582; B32B 2307/736; B32B 2439/06

(57) ABSTRACT

A directional tear packaging film that includes a fully coextruded and biaxially oriented film. The packaging film includes a polyamide layer. an ethylene vinyl alcohol copolymer blend layer and a sealant layer. The polyamide layer includes polyamide in an amount from 5% to 60% by weight of the packaging film. The ethylene vinyl alcohol copolymer (EVOH) blend layer includes an ethylene vinyl alcohol copolymer in an amount from 60% to 99% by weight of the EVOH blend layer and a polyethylene in an amount from 1% to 40% by weight of the EVOH blend layer. The packaging film includes a Shrinkage Value from 0% to 60% in each of the machine direction and the transverse direction when tested according to ASTM D2732-03 using bath temperature of 90° C.

### TECHNICAL FIELD

The present application is related to flexible, multilayered packaging film and packages produced from the films. In particular, the films include a shrinkage value, a polyamide layer and an ethylene vinyl alcohol copolymer blend layer. The films and packages demonstrate improved machine direction linear tear.

### BACKGROUND

Bags are commonly used for packaging various products, such as food and non-food items. In some applications, coextruded, oriented film structures, may be used to package food, such as meat or cheese, as well as non-food items. In some oriented film package applications, a shrink bag is formed of the film and the bags are typically pre-manufactured with a top seal and header incorporating various features such as handles, or seals to prevent curling. In other oriented film bag applications, the bags are a tube or a flow wrap package. The bags are often manufactured from multilayer polymer films that are highly engineered to provide properties such as oxygen barrier, abuse resistance, ability to seal through contamination, etc.

For tear open bags, the direction of tear propagation typically coincides with the predominant direction of molecular orientation. For compositionally simple films, this feature allows the film manufacturer to control the direction of tear by managing the processing conditions that influence molecular orientation. Higher performance packaging films, however, are assembled from layers of differing materials, for example, it is known by those skilled in the art that ethylene vinyl alcohol copolymer (EVOH), a common oxygen barrier component of a packaging film or polyamide, a common abuse resistant component of a packaging film, can be added to packaging films. The inclusion of these materials in a film structure increases the propensity for tearing in a direction perpendicular to the predominant molecular orientation direction that is the machine direction of the film creating unpredictable and unacceptable results. When a film structure includes both polyamide and ethylene vinyl alcohol copolymer, the deleterious cross direction tear of the film is compounded; that is, the film structures demonstrate difficulty in maintaining a straight or relatively straight machine direction tear due to the complex function of the individual tear behaviors of the component materials. Often, these films tear in undesirable directions that do not coincide with the preferred package opening direction. One of skill in the art recognizes that coextruded film structures that include polyamide or ethylene vinyl alcohol copolymer, resist tearing or show unpredictable tear.

Many tear-open oriented film bags suffer from inconsistent tearing performance when the tear propagates in the cross direction of the film. Users often resort to the use of sharp objects such as scissors, knives, etc., to open the bags that pose safety concerns, especially in a manufacturing setting. Additionally, the bag may not open at all (e.g., tears above the seal for tears initiating in a package header) or the bag is not opened enough to empty or remove the product from the bag.

### SUMMARY

A directional tear packaging film has been developed with superior tear open performance that can maintain a machine direction linear tear. The machine direction linear tear aids in removal of a product from a package formed from the packaging film and can reduce safety hazards associated with opening the package with sharp instruments. The present application describes a film composition that includes polyamide and ethylene vinyl alcohol copolymer in a fully coextruded, oriented and annealed film that includes improved machine direction linear tear.

One embodiment of a directional tear packaging film includes a fully coextruded and biaxially oriented film. The packaging film includes a polyamide layer, an ethylene vinyl alcohol copolymer (EVOH) blend layer and a sealant layer. The polyamide layer includes polyamide in an amount from 5% to 60% by weight of the packaging film. The ethylene vinyl alcohol copolymer blend layer includes an ethylene vinyl alcohol copolymer in an amount from 60% to 99% by weight of the EVOH blend layer and a polyethylene in an amount from 1% to 40% by weight of the EVOH blend layer. The packaging film includes a Shrinkage Value from 0% to 60% in each of the machine direction and the transverse direction when tested according to ASTM D2732-03 using bath temperature of 90° C.

In some embodiments, the directional tear packaging film EVOH blend layer polyethylene includes ultra-low density polyethylene, low density polyethylene, linear low density polyethylene, medium density polyethylene, ethylene vinyl acetate copolymer (EVA), or blends thereof.

In some embodiments, a bag may be formed from the directional tear packaging film where the bag includes a heat seal that is formed by heat sealing the sealant layer sealed to itself.

In one embodiment, a directional tear packaging film process includes the steps of a) coextruding layers in the following sequential order forming a directional tear packaging film: i) a polyamide layer including a polyamide in an amount from 5% to 60% by weight of the packaging film, ii) an ethylene vinyl alcohol copolymer blend layer (EVOH blend layer) including an ethylene vinyl alcohol copolymer in an amount from 60% to 99% by weight of the EVOH blend layer and a polyethylene in an amount from 1% to 40% by weight of the EVOH blend layer and iii) a sealant layer, b) biaxially orienting the directional tear packaging film, and c) annealing the directional tear packaging film where the directional tear packaging film includes a Shrinkage Value from 0% to 60% in each of the machine direction and the transverse direction when tested according to ASTM D2732 using bath temperature of 90° C.

In another embodiment, a directional tear packaging film process includes the steps of a) coextruding layers in the following sequential order forming a directional tear packaging film: i) a polyamide layer comprising a polyamide in an amount from 5% to 60% by weight of the packaging film, ii) an ethylene vinyl alcohol copolymer blend layer (EVOH blend layer) comprising an ethylene vinyl alcohol copolymer in an amount from 60% to 99% by weight of the EVOH blend layer and a polyethylene in an amount from 1% to 40% by weight of the EVOH blend layer and iii) a sealant layer;

and b) biaxially orienting the directional tear packaging film, where the directional tear packaging film comprises a Shrinkage Value from 0% to 60% in each of the machine direction and the transverse direction when tested according to ASTM D2732 using bath temperature of 90° C.

In some embodiments, the directional tear packaging film process includes the steps of coextruding, biaxially orienting and annealing occurring in a continuous in-line process.

In some embodiments, the directional tear packaging film process includes a triple bubble process.

In any embodiment, the directional tear packaging film Shrinkage Value includes from 0% to 10% in each of the machine direction and the transverse direction when tested according to ASTM D2732-03 using bath temperature of 90° C.

In any embodiment, the directional tear packaging film Shrinkage Value includes from 0% to 20% in each of the machine direction and the transverse direction when tested according to ASTM D2732-03 using bath temperature of 90° C.

There are several aspects of the present subject matter which may be embodied separately or together. These aspects may be employed alone or in combination with other aspects of the subject matter described herein, and the description of these aspects together is not intended to preclude the use of these aspects separately or the claiming of such aspects separately or in different combinations.

### BRIEF DESCRIPTION OF THE DRAWINGS

The disclosure may be more completely understood in consideration of the following detailed description of various embodiments of the disclosure in connection with the accompanying drawings, in which:

FIG. 1 is a schematic cross-sectional view of a first embodiment of a machine direction tear packaging film;

FIG. 2 is a schematic cross-sectional view of a tie layer of an embodiment of a machine direction tear packaging film;

FIGS. 3 is a schematic cross-sectional view of an alternate tie layer of an embodiment of a machine direction tear packaging film;

FIG. 4 is a schematic cross-sectional view of a second embodiment of a machine direction tear packaging film;

FIG. 5 is a schematic cross-sectional view of a third embodiment of a machine direction tear packaging film;

FIG. 6 is a schematic cross-sectional view of a fourth embodiment of a machine direction tear packaging film;

FIG. 7 is a top plan view of film sheet used for manual tear testing;

FIGS. 8-11 are top plan views of film sheets demonstrating tears indicative of machine direction linear tear according to the test method described herein;

FIGS. 12-13 are top plan views of film sheets demonstrating tears that are not indicative of machine direction linear tear according to the test method described herein;

FIG. 14 is a top plan view of a package in the form of a shrink bag according to the present application; and

FIG. 15 is a perspective view of a package in the form of a flow wrap bag disclosed according to the present application.

The elements depicted in the drawings are illustrative and not necessarily to scale, and the same (or similar) reference numbers denote the same (or similar) features throughout the drawings. It will be understood, however, that the use of a number to refer to a component in a given figure is not intended to limit the component in another figure labeled with the same number. The drawings show some but not all embodiments.

### DETAILED DESCRIPTION

A packaging film that demonstrates improved machine direction linear tear is disclosed herein. The packaging film is oriented to include a Shrinkage Value and may be a fully coextruded film that is annealed. The composition of one of the layers includes polyamide and another one of the layers includes ethylene vinyl alcohol copolymer (EVOH) blended with polyethylene. The film further includes a sealant layer. Further, a package can be made from the packaging film when the film is sealed to itself or to another suitable packaging film or material (exposed sealant surface to exposed sealant surface).

The term “film”, as used herein, refers to a polymeric web of any thickness.

The term, “machine direction linear tear”, as used herein, refers to the propensity of the film to tear along a reference line that is parallel to the direction of manufacture of the film (e.g., machine direction) where the reference line includes the initiation point of a tear line. The tear line may be a straight line and may follow the reference line or be parallel to the reference line. In other instances, the tear line may follow a straight line that is not parallel to the machine direction of the film but also demonstrates machine direction linear tear. That is, the tear line may have an initiation point on the reference line, however the tear line end point may deviate from the reference line by 0.0 mm (0.0 inches), 6.36 mm (0.64 cm, 0.25 inches), 12.7 mm (1.3 cm, 0.5 inches), 25.4 mm (1.0 cm, 1.0 inch), 38.1 mm (3.8 cm, 1.5 inches), 50.8 mm (5.1 cm, 2.0 inches), or any value in between. In yet other instances, the tear line may not be a straight line and may include points that form a curve (e.g., arc) or points that form various linear portions that are not parallel to the reference line, however all points of the tear line are a distance of 0.0 mm (0.0 inches), 6.36 mm (0.64 cm, 0.25 inches), 12.7 mm (1.3 cm, 0.5 inches), 25.4 mm (1.0 cm, 1.0 inch), 38.1 mm (3.8 cm, 1.5 inches), 50.8 mm (5.1 cm, 2.0 inches), or any value in between, from the reference line. In all instances, the reference line is a straight line that is parallel to the machine direction of the film that includes the tear initiation point.

The packaging film is an oriented film that includes a Shrinkage Value. The term “Shrinkage Value”, as used herein, refers to the amount of shrink exhibited by a film, the shrink amount being between 0% and 60%, and the film having this feature in both its machine direction (MD) and transverse or cross direction (TD) dimensions. Shrinkable films are produced through stretching of the film to make an oriented film. The term “oriented” as used herein, refers to a film, sheet, web, etc. that has been elongated in at least one of the MD or the TD. Such elongation is accomplished by procedures known in the art. The oriented film may be extruded using either flat or annular die type processes.

Orientation may be mono-directional (machine direction or transverse direction), or bi-directional (also called “bi-axial” or “bi-axially”) stretching of the film, increasing the machine direction and/or transverse direction dimension and subsequently decreasing the thickness of the material. Bi-directional orientation may be imparted to the film simultaneously or successively. Stretching in either or both directions is subjected to the film in the solid phase at a temperature just below the melt temperature of the polymers in the film. In this manner, the stretching causes the polymer chains to “orient”, changing the physical properties of the film. At the same time, the stretching thins the film.

The terms “shrinkage”, “shrinkable” and “shrink”, as used herein, refer to a property of a polymeric, packaging film manufactured in such a way that when it is exposed to a certain amount of heat, the film will contract in at least one direction along its length (MD) or width (TD), preferably in both directions, reducing its overall surface area. The Shrinkage Value is determined as by using ASTM D2732-03 and is defined to be the value obtained by measuring unrestrained (i.e., free) shrink of a 10 cm square specimen immersed in water at 90 degrees Celsius (° C.) for five seconds. Four test specimens are cut from a given sample of the packaging film to be tested with each specimen cut into squares of 10 cm length in the MD by 10 cm length in the TD. Each specimen is completely immersed for 5 seconds in a 90° C. water bath free from physical restraint. Upon removal of the specimen from the bath, the distance between the ends of the shrunken specimen is measured for both the MD and TD. The difference in the measured distance for the shrunken specimen and the original 10 cm side is multiplied by ten to obtain the percent of shrinkage for the specimen in each direction. The shrinkage of four specimens is averaged for the MD shrinkage value of the given film sample, and the shrinkage for the four specimens is averaged for the TD shrinkage value.

The packaging film may have 1) a MD Shrinkage Value from 0% to 60% shrink at 90° C., at least 10% shrink at 90° C., at least 16% shrink at 90° C., at least 20% shrink at 90° C., from 0% to 10% shrink at 90° C., from 0% to 20% shrink at 90° C., from 10% to 60% shrink at 90° C., or any value in between; and 2) a TD Shrinkage Value from 0% to 60% shrink at 90° C., at least 10% shrink at 90° C., at least 16% shrink at 90° C., at least 20% shrink at 90° C., from 0% to 10% shrink at 90° C., from 0% to 20% shrink at 90° C., from 10% to 60% shrink at 90° C., or any value in between. In some embodiments, the Shrinkage Value of the packaging film in each of the MD and the TD can be from 50% to 60%, 40% to 50%, 30% to 40%, 20% to 30%, 10% to 20%, 5% to 10%, 1% to 5%, or 0%. The packaging film MD Shrinkage Value and the TD Shrinkage value may be the same or differ from each other. In some embodiments, the MD Shrinkage Value and the TD Shrinkage Value may be the same; for example, the MD Shrinkage Value may be 50% and the TD Shrinkage Value may be 50%. In other embodiments, the MD Shrinkage Value and the TD Shrinkage Value may differ from each other. In one embodiment, the MD Shrinkage Value may be 45% and the TD Shrinkage Value may be 50%. In another embodiment, the MD Shrinkage Value may be 8% and the TD Shrinkage Value may be 20%. The MD Shrinkage Value and the TD Shrinkage Value may be tunable for the desired application of the packaging film.

The terms “coextruded”, “coextrude”, or “coextrusion”, as used herein, refer to the process of extruding two or more polymer materials through a single die with two or more orifices arranged so that the extrudates merge and weld together into a laminar structure before chilling (i.e., quenching). Examples of coextrusion methods known in the art include but are not limited to blown film (annular) coextrusion, slot cast coextrusion and extrusion coating. The flat die or slot cast process include extruding polymer streams through a flat or slot die onto a chilled roll and subsequently winding the film onto a core to form a roll of film for further processing.

The term “fully coextruded”, as used herein, refers to a coextruded film that is formed in a single processing step, by either blown film extrusion or cast extrusion.

The term “blown film”, as used herein, refers to a film produced by the blown extrusion process. In the blown extrusion process, streams of melt-plastified polymers are forced through an annular die having a central mandrel to form a tubular extrudate. The tubular extrudate may be expanded to a desired wall thickness by a volume of fluid (e.g., air or other gas) entering the hollow interior of the extrudate via the mandrel and then rapidly cooled or quenched by any of various methods known in the art.

The term “layer”, as used herein, refers to a structure of a single polymer-type or a homogenous blend of materials. A layer may be a single polymer, a blend of materials within a single polymer type or a blend of various polymers, may contain metallic materials, and may have additives. A layer may be continuous with the film, discontinuous or patterned. A layer may include sub-layers.

The packaging film of the present disclosure may be fully coextruded and multilayered. The packaging film includes one or more polyamide layers. The polyamide layer may include a single polyamide or a blended composition of polyamides. The amount of polyamide included in the packaging film is from 5% to 60% by weight of the packaging film or any percentage therebetween.

The terms, “polyamide” or “PA” or “nylon”, as used herein, refer to homopolymers or copolymers having recurring amide linkages and may be formed by any method known in the art. Recurring amide linkages may be formed by the reaction of one or more diamines and one or more diacids. Non-limiting examples of suitable diamines include 1,4-diamino butane, hexamethylene diamine, decamethylene diamine, metaxylylene diamine and isophorone diamine. Non-limiting examples of suitable diacids include terephthalic acid, isophthalic acid, 2,5-furandicarboxylic acid, succinic acid, adipic acid, azelaic acid, capric acid and lauric acid.

Polyamides may also be formed by the ring-opening polymerization of suitable cyclic lactams like ε-caprolactam, ω-undecanolactam and ω-dodecalactam.

Polyamide is used in films for food packaging and other applications because of its unique physical and chemical properties. Polyamide is selected as a material to improve temperature resistance, abrasion resistance, puncture strength and/or barrier of films. Properties of polyamide-containing films can be modified by selection of a wide variety of variables including copolymer selection, and converting methods (e.g. coextrusion, orientation, lamination, and coating).

Preferably, polyamides are selected from compositions approved as safe for producing articles intended for use in processing, handling and packaging of food. For example, nylon resins approved by the Food and Drug Administration are provided at 21 CFR § 177.1500 (“Nylon resins”), which is incorporated herein by reference. Non-limiting examples of these nylon resins for use in food packaging and processing include: nylon 66 (PA66), nylon 610, nylon 66/610, nylon 6/66 (PA6/66 or (poly(caprolactam-co-hexamethylene adipamide)), nylon 11 (poly(ω-undecanolactam)), nylon 6 (poly(ε-caprolactam)), nylon 66T, nylon 612, nylon 12 (poly(ω-dodecalactam)), nylon 6/12, nylon 6/69 (PA6/69 or poly(caprolactam-co-hexamethylene azelamide)), nylon 46, nylon PA 6-3-T, nylon MXD-6 (poly(m-xylylene adipamide)), nylon 12T and nylon 6I/6T (PA6I/6T or poly(hexamethylene terephthalamide-co-hexamethylene isophthalamide)) disclosed at 21 CFR § 177.1500.

Another layer of the packaging film includes a blended composition of ethylene vinyl alcohol copolymer (EVOH) and polyethylene that is an EVOH blend layer. The amount of EVOH included in the EVOH blend layer is from 60% to 99% by weight of the EVOH blend layer or any percentage therebetween. The amount of polyethylene included in the EVOH blend layer is from 1% to 40% by weight of the EVOH blend layer or any percentage therebetween. In an embodiment, the EVOH may be present in the EVOH blend layer in an amount from 60% to 99%, 65% to 90%, or from 70% to 80% by weight of the film layer that includes the blended EVOH and polyethylene composition. In an exemplary embodiment, the EVOH blend layer includes 90% EVOH by weight.

As used herein, the terms “ethylene vinyl alcohol copolymer”, “EVOH copolymer”, and “EVOH”, refer to copolymers comprised of repeating units of ethylene and vinyl alcohol. Ethylene vinyl alcohol copolymers may be represented by the general formula: [(CH2—CH2)n—(CH2—CH(OH))m]. Ethylene vinyl alcohol copolymers may include saponified or hydrolyzed ethylene vinyl acetate copolymers. In commercial grades of EVOH, the extent of saponification is very high (generally at least 97%), such that the presence of any unsaponified vinyl acetate groups is typically ignored. The EVOH composition is usually expressed in terms of its ethylene content and for commercial grades used in packaging applications, the ethylene content may range from 24 mole % to 50 mole %, though even broader compositions are produced for other applications. EVOH is commercially available in resin form with various percentages of ethylene.

A packaging film in accordance with the present disclosure may have an oxygen transmission rate (OTR). While some applications may require a generally lower OTR, there may be applications that the packaging film is not required to have a low oxygen barrier. In some embodiments, the OTR may be from 0.15 cc/m²/24 hours to 15.00 cc/m²/24 hours at 23° C., 0% Relative Humidity (RH) and 1 atmosphere. In any embodiment, the packaging film disclosed herein requires an EVOH blend layer regardless of the OTR requirements of the packaging film.

There are several broad categories of polymers and copolymers referred to as “polyethylene” as the term is used herein. Polyethylene homopolymer is generally described as being a solid which has amorphous and crystalline phases with a density of between 0.870 grams per cubic centimeter (g/cc) to 0.980 g/cc.

“High density polyethylene” (HDPE) refers to both (a) homopolymers of densities between about 0.960 g/cc to 0.980 g/cc and (b) copolymers of ethylene and an a-olefin (usually 1-butene, 1-hexene or 1-octene) that have densities between 0.940 g/cc and 0.958 g/cc.

“Medium density polyethylene” (MDPE) typically has a density from 0.928 g/cc to 0.940 g/cc. Medium density polyethylene includes linear medium density polyethylene (LMDPE).

Another grouping of polyethylene is “low density polyethylene” (LDPE). LDPE is used to denominate branched homopolymers having densities between 0.915 g/cc and 0.930 g/cc.

Copolymers of ethylene and at least one alpha-olefin or “ethylene alpha-olefin copolymers” may also be used in the EVOH blend layer. Ethylene alpha-olefins refer to a modified or unmodified copolymer produced by the co-polymerization of ethylene and any one or more alpha-olefins. Suitable alpha-olefins include, for example, C3 to C4 alpha-olefins such as 1-propene, 1-butene, 1-pentene, 1-hexene, 1-octenes 1˜decene, or blends of such materials. Homogeneous catalyzed copolymers of ethylene and alpha-olefin may include modified or unmodified ethylene alpha-olefin copolymers having a long-chain branched (i.e., 8-20 pendant carbons atoms) or short-chain branched (i.e., 3-6 pendant carbons atoms) alpha-olefin co-monomer, or linear copolymers. Ethylene alpha-olefin copolymers may include, for example, linear low density polyethylene (LLDPE), metallocene-catalyzed LLDPE (mLLDPE), very low density polyethylene (VLDPE), metallocene-catalyzed VLDPE (mVLDPE), ultra low density polyethylene (ULDPE) and plastomers. Linear low density polyethylene (including LLDPE and mLLDPE) may have a density of from 0.910 g/cc to 0.945 g/cc and very low density and ultra low density polyethylene (including VLDPE, mVLDPE, and ULDPE) may have a density of from 0.870 g/cc to 0.920 g/cc. Sometimes VLDPE's having a density less than 0.900 g/cc are referred to as plastomers.

Other examples of polyethylene copolymers include, but are not limited to, ethylene vinyl acetate copolymer (EVA), ethylene methyl acrylate copolymer (EMA), ethylene acrylic acid (EAA), and cyclic olefin copolymers (COC). Other polymers may include ionomers, and functional group-modified polymers including, e.g., anhydride-modified polyolefins.

In some embodiments, the polyethylene used in the EVOH blend layer may include ultra low density polyethylene, low density polyethylene, linear low density polyethylene, medium density polyethylene, ethylene vinyl acetate copolymer (EVA), or blends thereof.

In an embodiment, the polyethylene may be present in the EVOH blend layer in an amount from 1% to 40%, 10% to 35%, and may be from 20% to 30% by weight of the EVOH blend layer. In an exemplary embodiment, the EVOH blend layer includes 10% polyethylene by weight.

In an embodiment, the packaging film that includes the EVOH blend layer, may include the EVOH and polyethylene blend in the following ratios of EVOH to polyethylene, respectively, by weight of the EVOH blend layer: 99:1, 90:10, 85:15, 80:20, 75:25, 70:30, 65:35, or 60:40. In an exemplary embodiment, the ratio of EVOH to polyethylene by weight of the EVOH blend layer is 90:10.

The EVOH blend layer can further include processing additives or be blended with other materials, such as, but not limited to, polyolefins, pigments, etc. as is known in the art. The terms “processing aids” or “processing additives”, as used herein, refer to antilock agents, slip agents, stabilizing agents, release agents, lubricating agents, antioxidants, photoinitiators, primers, colorants, compatibilizers for film recycling capabilities, and other additives known to and used by a person of ordinary skill in the art without undue experimentation. The use of processing aids varies depending on the equipment, materials, desired aesthetics, desired performance properties, etc.

The packaging film can include one or more adhesive layers, also known in the art as “tie layers”, which can be selected to promote the adherence of adjacent layers to one another in a multilayer film. The terms “tie layer” or “adhesive layer”, as used herein, refer to a material placed on one or more layers, partially or entirely, to promote the adhesion of that layer to another surface. Preferably, adhesive layers are positioned between two layers of a multilayer film to maintain the two layers in position relative to each other and prevent undesirable delamination. Unless otherwise indicated, a tie layer or an adhesive layer can have any suitable composition that provides a desired level of adhesion with the one or more surfaces in contact with the adhesive layer material.

As used herein, “adjacent” means that there is no intervening material between the components.

As used herein, the terms “adhere,” “adherence, ” “adhesion”, and formatives thereof, as applied to film layers or other components of the present invention, are defined as affixing of the subject layer surface to another surface, with or without adhesive, and such that the layers or components are attached to each other and would require a force to separate them.

Tie layers, as generally known by a person of ordinary skill in the art, may be incorporated into the packaging film as appropriate. Multilayer films can comprise any suitable number of tie or adhesive layers of any suitable composition. Various adhesive layers are formulated and positioned to provide a desired level of adhesive between specific layers of the film according to the composition of the layers contacted by the tie layers. Non-limiting examples of commercial materials that would be suitable for use as the tie layers of the invention are as follows: ADMER SF755A, ADMER NF911E, ADMER SF730E, and ADMER SE810, all of Mitsui Chemicals America, Inc. of Rye Brook, NY 10573.

In embodiments where the layers comprise compatible polymers, the layers can be coextruded without the need for an intermediate adhesive (tie) layer. For example, a layer containing polyamide and a layer containing EVOH may have suitable adhesion to each other and do not require an adhesive layer therebetween. However, a tie layer may be necessary and may be present.

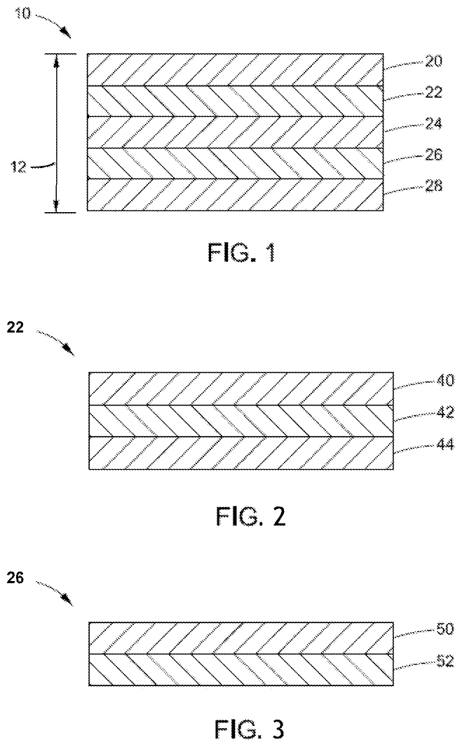

In accordance with the practice of at least one embodiment, as seen in FIG. 1, there is a directional tear packaging film 10. Each layer in the film 10 is positioned relative to each other layer in sequential order. There is a first polyamide layer 20 that is an exterior layer of the film 10. Next to the first polyamide layer 20 is adhered a first tie layer 22. Adhered to the first tie layer 22 is an EVOH blend layer 24. To the EVOH blend layer 24 is adhered a second tie layer 26. To second tie layer 26 is adhered a sealant layer 28 that is an interior layer of the film 10.

In the embodiment shown in FIG. 1, the first polyamide layer 20 is adjacent the first tie layer 22. Adjacent to the first tie layer 22 is the EVOH blend layer 24. Adjacent to the EVOH blend layer 24 is the second tie layer 26. The second tie layer 26 is adjacent to the sealant layer 28. In other embodiments, the first polyamide layer 20, the first tie layer 22, the EVOH blend layer 24, the second tie layer 26, and the sealant layer 28 may not be adjacent to each other and may include intervening layers. Intervening layers, for example, may include additional polyamide, polyethylene, EVOH, EVOH blend, or tie layers.

As used herein, the term “sealant layer” refers to a specific film layer, or layers, involved in the sealing of the film to itself or to another layer or another film sheet, etc. In general, the sealant material is a surface layer, that is, an exterior or an interior layer of any suitable thickness, that provides for the sealing of the film to itself or another layer or film or component. The sealant material may be a single material or a homogenous blend. Specific non-limiting examples of sealant layers include but are not limited to layers comprising polyethylene (such as LLDPE, a blend of LLDPE and LDPE, mLLDPE), polypropylene (such as a blend of random copolymer PP and PP plastomer), ionomer, or blends of any of the above. Heat seal coatings may be, but are not limited to, polyester based formulas, vinyl/acrylic copolymer based formulas, or polypropylene based formulas. Heat seal coatings may contain low melt temperature components such as waxes. Heat seal coatings that contain wax components may have heat seal initiation temperatures of less than 60° C., 85° C., 100° C. or less than 121° C.

The term “seal” and its formatives, as used herein, refers to the union of a surface (or portion thereof) of one film to a surface (or portion thereof) of another film or two different portions of a surface of the same film (e.g., sealant layer 28 to sealant layer 28). Seals may be formed by any known method including heat sealing, ultrasonic sealing, RF welding, etc.

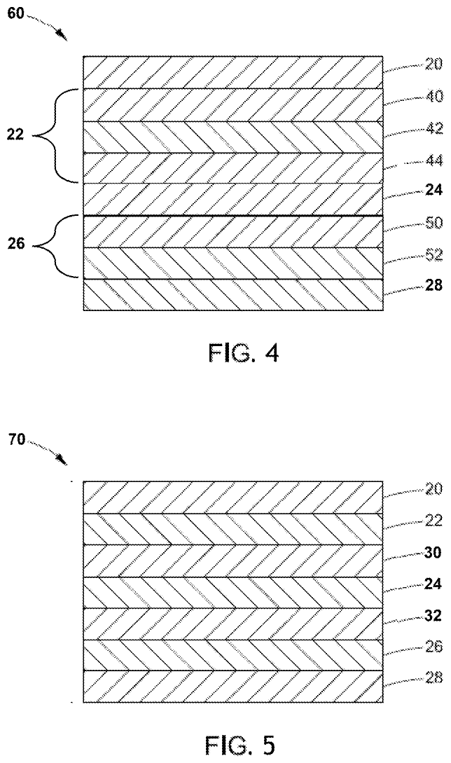

In some embodiments, the packaging film may include multiple sublayers in the first tie layer 22 or the second tie layer 26. Referring to FIG. 2, for example, a first sublayer that includes a tie material 40 is adhered next to a bulk layer 42 such as polyethylene, and then a second sublayer that includes a tie material 44 adhered thereto, and then layer 40 would adhere to the first polyamide layer 20. In other embodiments, as seen in FIG. 3, a second tie layer 26 includes a first sublayer that includes tie material 50 that is adhered to a bulk layer 52 such as polyethylene, and then layer 52 would adhere to sealant layer 28. FIG. 4 illustrates a packaging film 60 that is of similar structure to the packaging film 10 shown in FIG. 1. The packaging film 60 shown in FIG. 4 includes first tie layer 22 and second tie layer 26 where each of the first tie layer 22 and the second tie layer 26 includes multiple sublayers. In some embodiments, the packaging film may include more than one tie layer, where each tie layer may be the same or different from each other. For example, one tie layer may include multiple sublayers and another tie layer may not include sublayers, each tie layer includes multiple sublayers or none of the tie layers include multiple sublayers.

In addition to the importance of the relationship of the layers of the packaging film, is formation and performance of the film as a whole based on these layers. Regarding formation, the packaging film includes a thickness 12 (see FIG. 1) from 25.4 microns to 203 microns (1.0 mil to 8.0 mil) or any increment therebetween. In an embodiment, the thickness 12 can be from 30 microns to 200 microns, from 40 microns to 190 microns, from 50 microns to 180 microns, from 60 microns to 170 microns, from 70 microns to 160 microns, from 80 microns to 150 microns, from 90 microns to 140 microns, from 100 microns to 130 microns, or from 110 microns to 120 microns. The thickness 12 is determined as known by one of ordinary skill in the art, and preferably by ASTM F2251-03. Additionally, the packaging film 10 may be opaque, transparent and/or include printing or graphics.

In various non-limiting embodiments, the fully coextruded, oriented, machine direction linear tear packaging film may include the structures described below.
PA/first tie/EVOH blend/second tie/sealant layer

This structure is shown in FIG. 1 and previously described.
PA/first tie/PA/EVOH blend/PA/ second tie/sealant layer

This structure is shown in FIG. 5. The packaging film 70 includes additional, intervening layers of polyamide when compared to packaging film 10 that is shown in FIG. 1. The first polyamide layer 20 is adjacent to the first tie layer 22. The first tie layer 22 is adjacent to a second polyamide layer 30 and is positioned between the first polyamide layer 20 and the second polyamide layer 30. The EVOH blend layer 24 is adjacent to the second polyamide layer 30 and to a third polyamide layer 32. That is, the EVOH blend layer 24 is positioned between the second polyamide layer 30 and the third polyamide layer 32. The third polyamide layer 32 is adjacent to the second tie layer 26. The second tie layer 26 is adjacent to the sealant layer 28.
PA/first tie first sublayer/first tie bulk PE/first tie second sublayer/PA/EVOH blend/PA/second tie first sublayer/second tie bulk PE/sealant layer

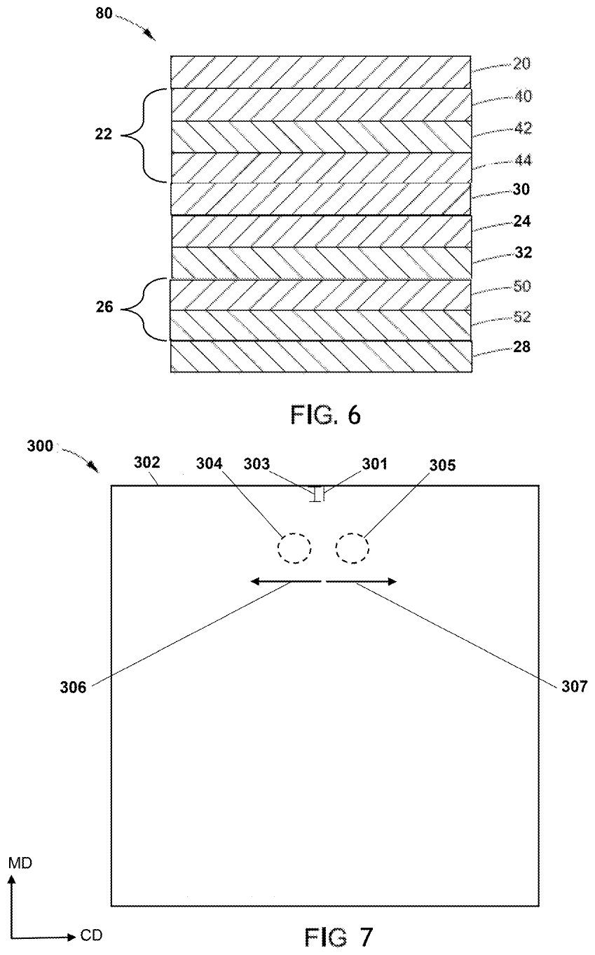

This structure is shown in FIG. 6. The packaging film 80 includes additional, intervening layers of polyamide when compared to packaging film 10 that is shown in FIG. 1. The first polyamide layer 20 is adjacent to the first tie layer 22 that includes multiple sublayers including the first sublayer that includes a tie material 40, the bulk layer 42 and the second sublayer that includes a tie material 44. The first tie layer 22 is adjacent to a second polyamide layer 30 and is positioned between the first polyamide layer 20 and the second polyamide layer 30. The EVOH blend layer 24 is adjacent to the second polyamide layer 30 and to a third polyamide layer 32. That is, the EVOH blend layer 24 is positioned between the second polyamide layer 30 and the third polyamide layer 32. The third polyamide layer 32 is adjacent to the second tie layer 26 that includes the first sublayer that includes tie material 50 and the bulk layer 52. The bulk layer 52 of the second tie layer 26 is adjacent to the sealant layer 28.

The packaging film may include as many polyamide, EVOH blend, tie, and intervening layers as necessary for the desired properties. The polyamide, EVOH blend and tie layers may be adjacent to each other.

Regarding performance, it has been unexpectedly found that the coextruded, oriented and annealed packaging film that includes a polyamide layer and an EVOH blend layer can provide improved machine direction linear tear. It is theorized that the EVOH blend layer counters the propensity for cross direction tear in a film that otherwise includes an EVOH layer. The combination of a polyamide layer and an EVOH blend layer can be used in applications that do not require high shrink when the packaging film is annealed to obtain machine direction linear tear. The overall packaging film structure and method of manufacture that includes coextruding a polyamide layer and an EVOH blend layer, orienting and annealing the packaging film provides improved machine direction linear tear of the packaging film.

With reference to FIG. 7, a manual, machine direction linear tear test method is described herein. A single film sheet 300 is cut to 30.48 cm by 30.48 cm (12 inches by 12 inches). The film sheet 300 may be collected without any particular aging conditions. The test method is conducted at a temperature of 23±2° C. and 50±5% relative humidity. The film sheet 300 includes a tear notch 301 from a first CD edge 302 of the sheet 300. The tear notch 301 is in the machine direction of the film sheet 300 at 15.24 cm (6 inches) from either MD edge. The tear notch 301 includes a notch length 303 of 1.27 cm (0.5 inches). The sheet is grasped by each of the tester's hands with a thumb placed on one surface of the sheet 300 and a corresponding index finger on the opposing surface of the sheet 300 in a first and second grasping region 304, 305, respectively. The first grasping region 304 and the second grasping region 305 are each approximately 2.54 cm (1 inch) away from the tear notch 301 in the cross direction of the sheet 300 and approximately 5.08 cm (2 inches) from the first CD edge 302. The sheet is held frontally to a tester's chest area at approximately 30.48 cm (12 inches). Each grasping region 304, 305 is pulled simultaneously away from each other laterally (e.g., in CD) as indicated by a first direction indicator 306 and a second direction indicator 307 at a rate of 25.4 cm (10 inches) per second that allows the tear to propagate in the machine direction of the sheet 300. Ten sheets per sample are torn and tear result is recorded.

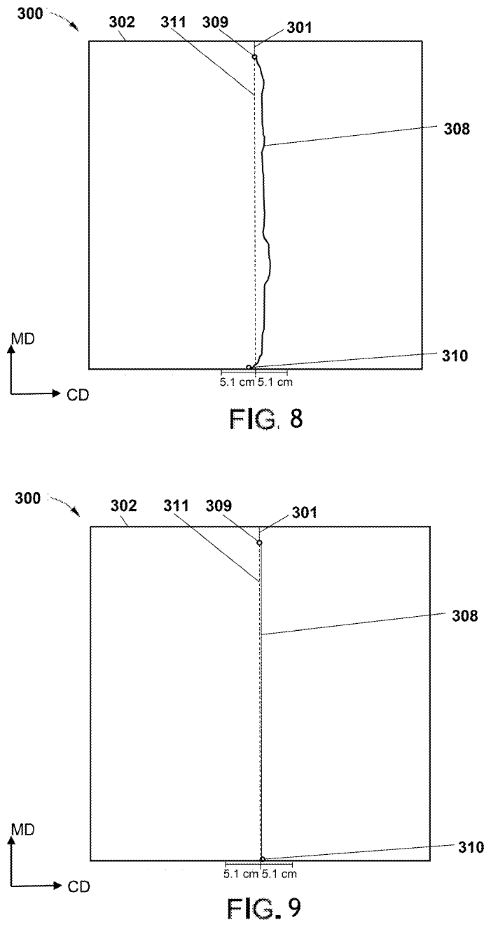

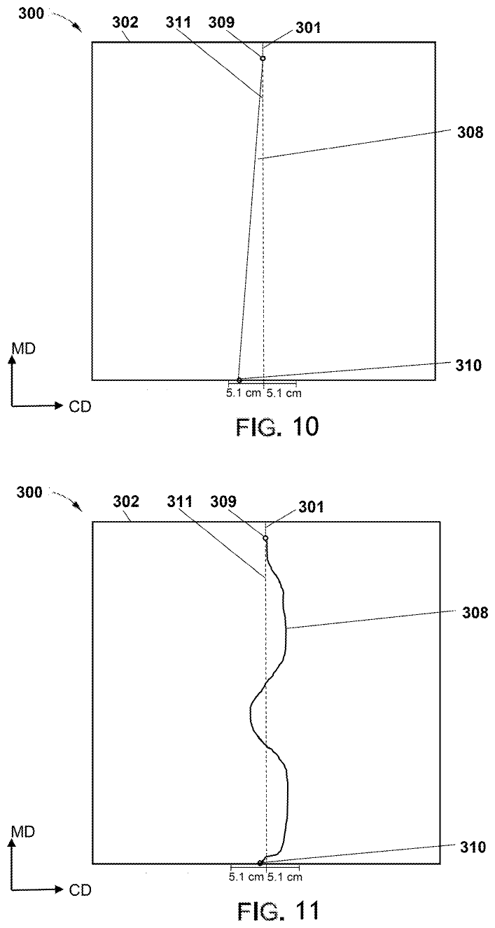

The results obtained from tearing the sheet according to the above-described manual test method may be indicative of machine direction linear tear of the packaging films of the present disclosure. Tear lines that may be straight, nearly straight or may deviate (e.g., weave, zig-zag) from a machine direction tear centerline approximately (e.g., reference line) 0.0 cm to 5.1 cm (0.0 inches to 2.0 inches) along the length of the tear are indicative of packages formed from the packaging film that may be more easily opened or that can be opened that allow the contained product to be removed. With reference to FIG. 8, a sheet 300 includes a tear line 308 that is nearly straight between an initiation point 309 and an end point 310 of the tear line 308 and that is within 5.1 cm from a machine direction tear centerline 311. Now referring to FIG. 9, a sheet 300 includes a tear line 308 that is straight between an initiation point 309 and an end point 310 of the tear line 308 and that is parallel to a machine direction tear centerline 311. With reference to FIG. 10, a sheet 300 includes a tear line 308 that is straight between an initiation point 309 and an end point 310 of the tear line 308 and that is not parallel to a machine direction tear centerline 311. FIG. 11 illustrates a sheet 300 that includes a tear line 308 that crosses a machine direction centerline 311 and that is within 5.1 cm on each side of the machine direction centerline 311. FIGS. 8-11 show non-limiting examples of machine directional linear tear of the packaging films described herein.

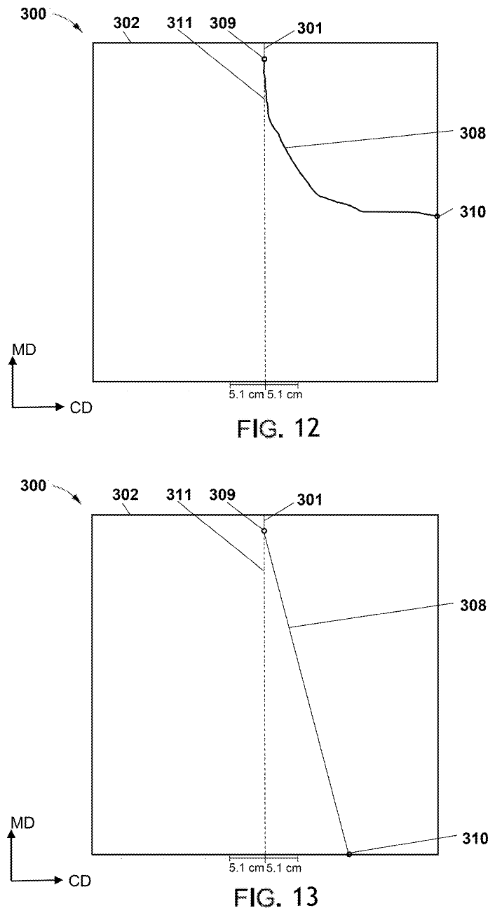

Tear lines that have end points further than approximately 5.1 cm from a machine direction tear centerline may be indicative of packages formed from the packaging film that may not be easily opened or opened enough to allow the contained product to be removed. With reference to FIG. 12, a sheet 300 is shown with a tear line 308 that has an end point 310 greater than 5.1 cm from the machine direction centerline 311 and that curves sharply such that the end point 310 is along one of the MD edges of the sheet 300. Now referring to FIG. 13, a sheet 300 is shown with a tear line 308 that is straight and includes an end point 310 that is greater than 5.1 cm from a machine direction centerline 311. FIGS. 12-13 show non-limiting examples of tears that are not considered to be machine directional linear tears.

ASTM D1922-09, Standard Test Method for Propagation Tear Resistance of Plastic Film and Thin Sheeting by Pendulum Method, (Elmendorf Tear), can also be used as an indicator of machine direction linear tear of films. The length of the tear obtained with ASTM D1922 is much shorter than the length of the tear obtained from the manual test method described herein due to the smaller sample size. However, the tears obtained with ASTM D1922 are still indicative of packaging film tear performance. Tears that may be parallel to a straight line in the machine direction of the film that includes the tear initiation point may indicate machine direction linear tear in a film. Tears that may not be parallel to or may veer off of or away from a straight line in the machine direction of the film that includes the tear initiation point may indicate that the film does not include machine direction liner tear, or in other words, includes poor machine direction tear. Additionally, the force in grams to propagate tearing across a film may be relatively indicative of machine direction linear tear. For example, among comparative films, a low force value may be indicative of films having machine direction tear because less force is required for the film to tear along the machine direction of the film.

A process for forming the packaging film includes first coextruding each layer positioned relative to each other layer in the order discussed above to form the packaging film. Another step is forming the packaging film to a thickness from 25.4 microns to 203.0 microns (1.0 mil to 8.0 mil). Still another step is imparting a Shrinkage Value to the packaging film from 0% to 60% by orienting and annealing the film. Finally, the process requires imparting acceptable machine direction linear tear to the packaging film by heat setting the film.

In one embodiment, the desired performance characteristics can be achieved where both imparting steps include 1) orienting the multilayer packaging film, and even more preferably biaxially orienting the packaging film, and 2) annealing the packaging film. In another embodiment, the steps of coextruding, orienting and annealing occur in a continuous in-line process. In yet another embodiment, the packaging film is formed by a triple bubble process as described below.

Non-limiting examples of procedures to form the packaging film include the single bubble blown film extrusion process and the slot cast sheet extrusion process with subsequent stretching, for example, by tentering, to provide orientation. Another example of such procedure is the trapped bubble, double bubble or triple bubble processes; see, for example, U.S. Pat. Nos. 3,546,044 and 6,511,688, each of which is incorporated in its entirety in this application by this reference. In the trapped bubble, double bubble or triple bubble processes, an extruded primary tube leaving the tubular extrusion die is cooled, collapsed and then, oriented by reheating, reinflating to form a secondary bubble and recooling, and then, if desired, further oriented (or relaxed) by reheating, reinflating to form a tertiary bubble and recooling. Transverse direction orientation may be accomplished by inflation, radially expanding the heated film tube. Machine direction orientation may be accomplished by the use of nip rolls rotating at different speeds, pulling or drawing the film tube in the machine direction. The combination of elongation at elevated temperature followed by cooling causes an alignment of the polymer chains to a more parallel configuration, thereby improving the mechanical properties of the packaging film.

After the layers of the packaging film have been assembled, orientation of the film is performed. The amount of orientation imparted on the base film can affect the properties thereof. It has been found that in the case of a machine direction oriented base film, stretching of at least 2× (2 times) leads to optimal film properties, such as stiffness and appearance. However, in some embodiments the base film may be stretched to a level less than 2×. In other embodiments the base film may be machine direction stretched at least 2.5×, 3.0×, 3.5×, 4×, 5×, 6×, any value in between these, or more. In other words, the dimension of the film is increased 2 times the original length, increased 2.5 times the original length, etc. Biaxially oriented base films may be stretched at similar levels as mono-oriented films, through either a tenter-frame process (flat die) or a bubble process (tubular die).

Also important to the properties of the packaging film is the annealing process. After orientation, the films have an embedded stress. Upon heating the film, this stress may be released, causing the films to shrink back to the original, pre-orientation, dimensions. Shrinkage of the packaging film may be undesirable for some applications as it may result in poor appearance in the heat seal area of the package or may prove difficult to apply printed indicia, as this process generally uses high temperatures. The process of annealing can help alleviate the embedded stress caused by orientation and the film will be “heat set” such that it will not shrink back to the original size at lower operating temperatures. It has been found that annealing the film at a temperature of about 120° C. using annealing rollers, results in a packaging film that can provide improved machine direction linear tear. Annealing is typically accomplished in-line through high diameter rollers set up at temperatures a few degrees lower than the melting point of the polymer or blend of polymers present in the film. However, annealing can be done by any known means including hot air or IR heating. Annealing level of the packaging films may be defined by a reduction in the Shrinkage Value of the packaging film from a pre-annealed state to a post-annealed state. The packaging film may be oriented to include an initial Shrinkage Value that may be from 40% to 60% and the packaging film is then annealed to a final Shrinkage Value. For example, a packaging film that includes a Shrinkage Value of 0% indicates that the packaging film has been fully annealed. In some embodiments, the packaging film may not be annealed.

Further, one of ordinary skill in the art would know, in combination with the teachings herein, to achieve the desired performance characteristics of the packaging film, to make these or other adjustments: (i) increase or decrease the Blow Up Ratio (a well-known term in this art) and/or the Draw Ratio (a well-known term in this art) in the orienting section of the blown film forming machine, (ii) increase or decrease the orienting temperature and cooling settings impacting the film during formation, and (iii) increase or decrease annealing relaxation percentage and temperature, impacting the film during package formation and use.

The packaging film produced may be used in a variety of applications, including packaging food and non-food items. Example items can be, but are not limited to dry foods, liquids, nuts, candy, snacks, fresh foods, frozen foods, beverages, pharmaceuticals, nutraceuticals, cosmetics, hard-to-hold products, cleaners, chemicals, wipes, medical products, electronic devices, pet foods/treats, bulk products, etc. Further non-limiting examples of food items that may be packaged in packages formed from the packaging film include meats and cheeses, including but not limited to large cuts of meat and large blocks of cheese, and further yet, a meat (such as ham) that is cooked in the package prior to sale to the end-user.

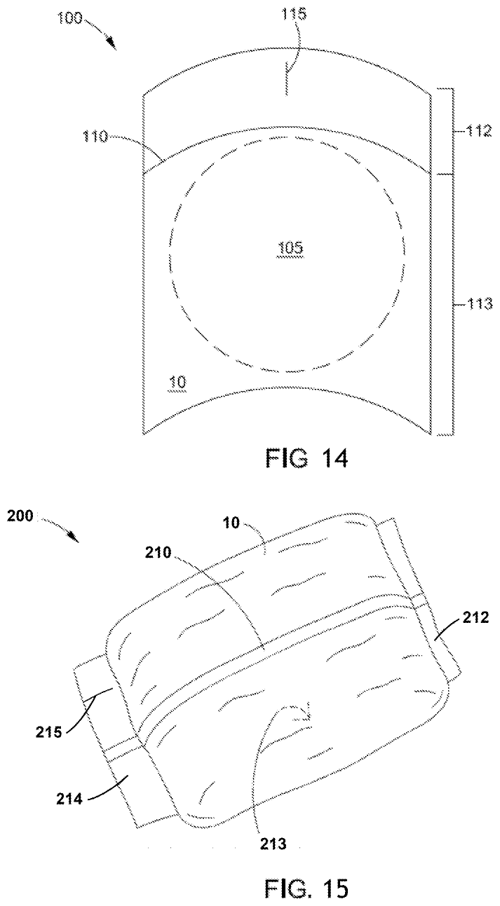

The packaging film can be formed into various types of packages (e.g., packaging containers). The package can be any type of container or bag. For example, the term “bag”, as used herein, refers to pouches and flexible packages made from flexible films having 1, 2, 3, 4 or more seals. In some embodiments, the package is a flow wrap package, a pouch or a shrink bag. A shrink bag can be formed from a tube of blown film. The tube can be cut in the transverse direction and sealed at one end to form a bag. FIG. 14 is a schematic top view of a first embodiment of a package 100 according to the present application that is a shrink bag. The contents can be inserted via the opposite end from a sealed end and then the opposite end is sealed to form a closed package. As depicted in FIG. 14, a product (e.g., food) 105 is placed into the shrink bag package 100. The package 100 is sealed with a top seal 110 where a header area 112 is formed above the top seal 110 and a product space portion 113 is formed below the top seal 110. The bag 100 is then exposed to heat to shrink the packaging film 10 to be in closer proximity to the product 105 contained therein. However, the shrink bag package 100 is not limited to this shape. In other embodiments, the package 100 may be of various shapes, including rectangle, square, parallelogram, etc. In some embodiments, the package 100 may not include a header 112 In some embodiments, the Shrinkage Value of the packaging film 10 used for a package 100 in the form of a shrink bag may be from 50% to 60%, 40% to 50%, 30% to 40%, 20% to 30%, 10% to 20%, or, in some instances, from 5% to 10% in each of the MD and the TD. An exemplary application of the described shrink bag package 100 may be for packaging large cuts of meat and large blocks of cheese.

In other embodiments, the package is a flow wrap package as depicted in FIG. 15. Flow wrap packages are formed from using what is generally known as form-fill-seal equipment. In the form-fill-seal arrangement, flexible packaging film is fed from a rollstock to a tube former where a tube is fashioned from the film into an open tube having the longitudinal edges sealed in an overlapping manner (i.e., lap seal) or a fin seal as is known in the art. The ends of the tube are sealed together by a pair of transverse heat seals which are vertically spaced apart whereas the tube may be filled with product prior to the ends being sealed. Simultaneously with or shortly after sealing the ends, the tube is transversely severed by cutting in a space between the spaced apart pair of transverse heat seals. Finally, the tube is advanced and the cycle is successively repeated so as to form a multiplicity of individually packaged flow wrapped products. Referring now to FIG. 15, a perspective view of a package 200 in the form of a flow wrap bag is shown. Package 200 is formed from the packaging film 10, 60, 70 by provision of a longitudinal fin seal 210 and first and second opposing spaced apart transverse seals 212, 214. Package 200 is filled with a product 213. The package 200 may be of various shapes, including rectangle, square, parallelogram, etc. In some embodiments, the Shrinkage Value of the packaging film 10 used for a package 200 in the form of a flow wrap bag may be from 0% to 5%, 5% to 10%, or in some instances, from 10% to 20% in each of the MD and the TD. An exemplary application of the described flow wrap bag package 200 may be for master bags (e.g., mother bags, master containers) that contain multiple, individually wrapped food packages, such as meat products that can be displayed in a retail setting upon removal from the package 200.

In some embodiments, the package may be formed from separate packaging films that are sealed near the edges to form a bag (e.g., sachet, pouch, pillow bag, etc.). In other embodiments, the packaging film may be formed via cold forming, thermoforming and/or vacuum forming for the formation of a pocket. For example, some packages, such as those that may contain deli meats, include a shallow pocket (approximately 15 mm to 25 mm) in the packaging film that is desirable for holding or assisting to hold the package contents in place. In another example, the packaging film may be formed such that a pocket that is deeper than the shallow pocket is formed.

In many instances, the opening feature (e.g., where the package is to be torn open) of the package 100, 200 is in the machine direction of the packaging film 10. The packages 100, 200 may further include a tear initiator. The tear initiator may be a continuous or non-continuous series of holes (e.g., finger holes), slits, slots, perforations, notches, punctures, orifices, openings, gaps, scratches, scores, knurls, or otherwise as known in the art. A tear initiator 115, 215 is shown as a slit in each of the packages 100, 200 illustrated in FIGS. 14 and 15, respectively.

In various embodiments, the tear initiator may be formed by mechanical means (e.g., using a cutting blade), by chemical means (e.g., using solvents), by thermal means (e.g., by optical ablation including but not limited to laser), or by other means known in the art. In various embodiments, the tear initiator has varying depth, and in some embodiments, extends through the entire thickness of the packaging film. Such tear initiators may be used on one or more edges or portions of the disclosed packages. Additionally, in various embodiments, the tear initiator may be of varying length, within a heat seal or may be in an unsealed area.

### EXAMPLES

TABLE 1
Film Structures

| | |
|---|---|
| Example A | PA/t/EVOH/t/sealant |
| Comparative | PA/t/EVOH/t/sealant |
| Example B | |
| Comparative | PE/t/EVOH/t/sealant |
| Example C | |
| Example D | PA/t/PE/t/PA/EVOH/PA/t/PE/PE/PE |
| | sealant |
| Comparative | PA/t/PE/t/PA/EVOH/PA/t/PE/PE/PE |
| Example E | sealant |
| Comparative | PA/t/PA/EVOH/PA/t/PE sealant |
| Example F | |
| Comparative | PA/t/PA/EVOH/PA/t/PE sealant |
| Example G | |
| Comparative | PA/t/PA/t/PA/t/PE sealant |
| Example H | |
| Comparative | PA/t/PE/t/PA/EVOH/PA/t/PE/PE/PE |
| Example I | sealant |
| Comparative | PA/t/PA/EVOH/PA/t/PE sealant |
| Example J | |

Tie layers are designated by “t”.

Example A: A 50.8 micron (2.0 mil) thick, coextruded film was produced on a blown film line and was biaxially oriented. The polyamide used was a blend including PA6, PA6/69 and PA6I/6T and was included in an amount of 10.6% by weight of the packaging film. The EVOH containing layer included 90% EVOH by weight of the EVOH containing layer. The tie layers included standard tie layer material as known by one of skill in the art. The sealant layer included a PE material or a PE blend material as known by one of skill of the art. The material was IR heated, oriented at an orientation draw ratio of at least 2.5 and an orientation blow up ratio of at least 2.5, and annealed inline.

Comparative Example B: Produced in accordance to Example A except that the EVOH containing layer included 100% EVOH by weight of the EVOH containing layer.

Comparative Example C: A 40.6 micron (1.6 mil) thick, coextruded film was produced on a blown film line and was biaxially oriented. The polyethylene used in the exterior, non-sealant layer included density from 0.860-0.906 g/cc³ and a Melt Index of 1 g/10 min. The EVOH containing layer included 90% EVOH by weight of the EVOH containing layer. The material was IR heated, oriented with blow point nip at an orientation draw ratio of at least 2.5 and an orientation blow up ratio of at least 2.5, and annealed inline.

Example D: A 50.8 micron (2.0 mil) thick, coextruded film was produced on a blown film line and was biaxially oriented. The polyamide used was PA6 and was included in an amount of 37% by weight of the packaging film. The EVOH containing layer included 90% EVOH by weight of the EVOH containing layer. The material was IR heated, oriented with blow point nip at an orientation draw ratio of at least 2.5 and an orientation blow up ratio of at least 2.5, and annealed inline.

Comparative Example E: A 50.8 micron (2.0 mil) thick, coextruded film was produced on a blown film line and was biaxially oriented. The polyamide used was PA6 and was included in an amount of 37% by weight of the packaging film. The EVOH containing layer included 100% EVOH by weight of the EVOH containing layer. The material was IR heated, oriented with blow point nip at an orientation draw ratio of at least 2.5 and an orientation blow up ratio of at least 2.5, and annealed inline.

Comparative Example F: A 50.8 micron (2.0 mil) thick, coextruded film was produced on a cast film line and was monoaxially oriented in the machine direction. The polyamide used was PA6 and was included in an amount of 37% by weight of the packaging film. The EVOH containing layer included 100% EVOH by weight of the EVOH containing layer. The material was not annealed.

Comparative Example G: A 50.8 micron (2.0 mil) thick, coextruded film was produced on a blown film line and was biaxially oriented. The polyamide used was a blend including PA6, PA6/66 and PA6I/6T (30%/45%/25%) and was included in an amount of 30.4% by weight of the packaging film. The EVOH containing layer included 100% EVOH by weight of the EVOH containing layer. The material was IR heated, oriented with blow point nip at an orientation draw ratio of at least 2.5 and an orientation blow up ratio of at least 2.5, and annealed inline.

Comparative Example H: A 44.45 micron (1.75 mil) thick, coextruded film was produced on a blown film line and was biaxially oriented. The polyamide used was a blend including PA6, PA6/69 and PA6I/6T (35%-40%/40%/20%-25%) and was included in an amount of 26.8% by weight of the packaging film. The EVOH containing layer included 0% EVOH by weight of the EVOH containing layer. The material was IR heated, oriented with blow point nip at an orientation draw ratio of at least 2.5 and an orientation blow up ratio of at least 2.5, and annealed inline.

Comparative Example I: A 29.21 micron (1.15 mil) thick, coextruded film was produced on a blown film line and was biaxially oriented. The polyamide used was PA6 and was included in an amount of 37% by weight of the packaging film. The EVOH containing layer included 100% EVOH by weight of the EVOH containing layer. The material was IR heated, oriented with blow point nip at an orientation draw ratio of at least 2.5 and an orientation blow up ratio of at least 2.5, and annealed inline.

Comparative Example J: A 50.8 micron (2.0 mil) thick, coextruded film was produced on a blown film line. The polyamide used was PA6 and was included in an amount of 18% by weight of the packaging film. The EVOH containing layer included 100% EVOH by weight of the EVOH containing layer.

TABLE 2 illustrates embodiments of the machine direction linear tear packaging film, Examples A and D, that demonstrate machine direction linear tear as described herein, compared to films that do not include machine direction linear tear as described herein, Comparative Examples B, C and E-J. Comparative Examples F and J are not annealed. Examples A and D and Comparative Examples B and E-J include a polyamide layer; Comparative Example C does not include polyamide. Examples A and D and Comparative Example C include an EVOH blend layer. Comparative Examples B, E, F, G, I, and J include an EVOH layer; Comparative Example H does not include an EVOH layer. Comparative Example F is mono-oriented in the machine direction, Examples A and D and Comparative Examples B-C, E, G, H, and I are biaxially oriented, and Comparative Example J is not oriented. Examples A and D are biaxially oriented, include a polyamide layer and an EVOH blend layer, and demonstrate machine direction linear tear as described by the disclosure herein.

TABLE 2

| | | Compar- | Compar- | | Compar- | Compar- | Compar- | Compar- | Compar- | Compar- |
|---|---|---|---|---|---|---|---|---|---|---|
| | | ative | ative | | ative | ative | ative | ative | ative | ative |
| | Example | Example | Example | Example | Example | Example | Example | Example | Example | Example |
| | A | B | C | D | E | F | G | H | I | J |
| Shrinkage Value | 45-50 | 49-50 | 49-50 | 5-5 | 5-5 | 8-4 | 40-45 | 40-45 | 16-20 | 0-0 |
| (%) MD − TD | | | | | | | | | | |
| PA Amount (% | 10.6 | 10.6 | 0 | 37 | 37 | 37 | 30.4 | 26.8 | 37 | 18 |
| of packaging | | | | | | | | | | |
| film) | | | | | | | | | | |
| EVOH Amount* | 90 | 100 | 90 | 90 | 100 | 100 | 100 | 0 | 100 | 100 |
| (% of EVOH | | | | | | | | | | |
| in EVOH- | | | | | | | | | | |
| containing | | | | | | | | | | |
| layer) | | | | | | | | | | |
| MD Linear | Yes; tear | No; tear | No; tear | Yes; tear | Yes; tear | No; tear | No; tear | No; tear | No; tear | No; tear |
| Tear; Manual | nearly | veers | veers | nearly | is zig- | veers | veers | veers | veers | veers |
| Test Method | parallel to | towards | towards | parallel to | zag line, | towards | towards | towards | towards | towards |
| | reference | one CD | one CD | reference | crosses | one CD | one CD | one CD | one CD | one CD |
| | line | edge | edge | line | either | edge | edge | edge | edge | edge |
| | | | | | side of | | | | | |
| | | | | | reference | | | | | |
| | | | | | line | | | | | |

*90% = EVOH blend layer; 100% = EVOH layer

TABLE 3 includes MD Elmendorf Tear force reported in grams.

TABLE 3

| | | | |
|---|---|---|---|
| | Comparative | Comparative | Comparative |
| Example D | Example E | Example G | Example J |

| | |
|---|---|
| 200 g pendulum | 800 g pendulum |

| | | | |
|---|---|---|---|
| 33.5 | 35.6 | 441.0 | 373.2 |

The degree of orientation imparted on a polymeric and transparent film was measured using the following test method. A light box (e.g., Porta Trace Light Box from Gagne, Inc.) is set up with a light polarizing film on the surface. This first polarizing film is mounted with the polarization direction oriented 45 degrees from the side edge of the light box. A second polarized film should be mounted 10.2 cm to 25.4 cm (4 inches to 10 inches) above the first polarizing film with the polarization direction oriented 90 degrees from the polarization direction of the first polarizing film. The sample of the film to be tested should be placed between the polarizing films with the machine direction of the film aligned with the side of the light box. The color of the film can be determined by viewing the sample through the second polarizing film after the light box has been turned on. The degree of orientation can be assessed by the colors seen. Films with little or no orientation appear to be black, gray or white (or likely a mix of these colors). As orientation increases, other colors appear, starting with yellow and advancing through orange, blue, and purple. Often the colors are mixed or vary.

Various film structures were coextruded and tested for orientation. Some of the film samples were oriented as well. The results can be seen in TABLE 4. The test results indicate how this test can be used to verify orientation of a film.

TABLE 4

| | Orientation Test Results |
|---|---|
| Film Description | (Color Observed) |
| Polyethylene film, machine direction oriented | Green |
| 6X | |
| Polyethylene film, machine direction oriented | Yellow |
| 3X | |
| Polyamide/Polyethylene film, machine | Orange/Blue/Green |
| direction oriented 2X | |
| Polyamide film, machine direction oriented | Blue/Green/Purple |
| 2.5X | |
| Polyamide film, machine direction oriented | Blue/Green/Purple |
| 3.0X | |
| Polyamide film, machine direction oriented | Green/Purple |
| 3.5X | |
| Polyamide/Polyethylene film, no orientation | White |

### Embodiments

A. A directional tear packaging film that includes a fully coextruded and biaxially oriented film that includes a polyamide layer that includes a polyamide in an amount from 5% to 60% by weight of the packaging film, an ethylene vinyl alcohol copolymer blend layer (EVOH blend layer) that includes an ethylene vinyl alcohol copolymer in an amount from 60% to 99% by weight of the EVOH blend layer and a polyethylene in an amount from 1% to 40% by weight of the EVOH blend layer, and a sealant layer, where the packaging film comprises a Shrinkage Value from 0% to 60% in each of the machine direction and the transverse direction when tested according to ASTM D2732-03 using bath temperature of 90° C.

B. A directional tear packaging film process that includes coextruding layers in the following sequential order forming a directional tear packaging film: i) a polyamide layer including a polyamide in an amount from 5% to 60% by weight of the packaging film, ii) an ethylene vinyl alcohol copolymer blend layer (EVOH blend layer) including an ethylene vinyl alcohol copolymer in an amount from 60% to 99% by weight of the EVOH blend layer and a polyethylene in an amount from 1% to 40% by weight of the EVOH blend layer and iii) a sealant layer, biaxially orienting the directional tear packaging film, and annealing the directional tear packaging film, where the directional tear packaging film includes a Shrinkage Value from 0% to 60% in each of the machine direction and the transverse direction when tested according to ASTM D2732 using bath temperature of 90° C.

C. A directional tear packaging film process that includes coextruding layers in the following sequential order forming a directional tear packaging film: i) a polyamide layer comprising a polyamide in an amount from 5% to 60% by weight of the packaging film, ii) an ethylene vinyl alcohol copolymer blend layer (EVOH blend layer) comprising an ethylene vinyl alcohol copolymer in an amount from 60% to 99% by weight of the EVOH blend layer and a polyethylene in an amount from 1% to 40% by weight of the EVOH blend layer and iii) a sealant layer and biaxially orienting the directional tear packaging film, where the directional tear packaging film comprises a Shrinkage Value from 0% to 60% in each of the machine direction and the transverse direction when tested according to ASTM D2732 using bath temperature of 90° C.

D. The directional tear packaging film according to any embodiment A.-C., where the Shrinkage Value includes from 0% to 10% in each of the machine direction and the transverse direction when tested according to ASTM D2732-03 using bath temperature of 90° C.

E. The directional tear packaging film according to any embodiment A.-D., where the Shrinkage Value includes from 0% to 20% in each of the machine direction and the transverse direction when tested according to ASTM D2732-03 using bath temperature of 90° C.

F. The directional tear packaging film of any embodiment A.-E., where the EVOH blend layer polyethylene includes ultra-low density polyethylene, low density polyethylene, linear low density polyethylene, medium density polyethylene, ethylene vinyl acetate copolymer (EVA), or blends thereof.

G. A bag formed from the directional tear packaging film of any embodiment A.-F., where the bag comprises a heat seal that is formed by heat sealing the sealant layer sealed to itself.

H. The directional tear packaging film process of embodiment B., where the steps of coextruding, biaxially orienting and annealing occur in a continuous in-line process.

I. The directional tear packaging film process of embodiment B. or H., comprising a triple bubble process.

Each and every document cited in this present application, including any cross referenced, is incorporated in this present application in its entirety by this reference, unless expressly excluded or otherwise limited. The citation of any document is not an admission that it is prior art with respect to any embodiment disclosed in this present application or that it alone, or in any combination with any other reference or references, teaches, suggests, or discloses any such embodiment. Further, to the extent that any meaning or definition of a term in this present application conflicts with any meaning or definition of the same term in a document incorporated by reference, the meaning or definition assigned to that term in this present application governs.

The description, examples, embodiments, and drawings disclosed are illustrative only and should not be interpreted as limiting. The present invention includes the description, examples, embodiments, and drawings disclosed; but it is not limited to such description, examples, embodiments, or drawings. As briefly described above, the reader should assume that features of one disclosed embodiment can also be applied to all other disclosed embodiments, unless expressly indicated to the contrary. Modifications and other embodiments will be apparent to a person of ordinary skill in the packaging arts, and all such modifications and other embodiments are intended and deemed to be within the scope of the present invention.

1. A directional tear packaging film comprising a fully coextruded and biaxially oriented film comprising:
a polyamide layer comprising a polyamide in an amount from 5% to 60% by weight of the packaging film;
an ethylene vinyl alcohol copolymer blend layer (EVOH blend layer) comprising an ethylene vinyl alcohol copolymer in an amount from 60% to 99% by weight of the EVOH blend layer and a polyethylene in an amount from 1% to 40% by weight of the EVOH blend layer; and
a sealant layer;
wherein the packaging film comprises a Shrinkage Value from 0% to 60% in each of the machine direction and the transverse direction when tested according to ASTM D2732-03 using bath temperature of 90° C.

2. The directional tear packaging film of claim 1, wherein the Shrinkage Value comprises from 0% to 10% in each of the machine direction and the transverse direction when tested according to ASTM D2732-03 using bath temperature of 90° C.

3. The directional tear packaging film of claim 1, wherein the Shrinkage Value comprises from 0% to 20% in each of the machine direction and the transverse direction when tested according to ASTM D2732-03 using bath temperature of 90° C.

4. The directional tear packaging film of claim 1, wherein the EVOH blend layer polyethylene comprises ultra-low density polyethylene, low density polyethylene, linear low density polyethylene, medium density polyethylene, ethylene vinyl acetate copolymer (EVA), or blends thereof.

5. A bag formed from the directional tear packaging film of claim 1, wherein the bag comprises a heat seal that is formed by heat sealing the sealant layer sealed to itself.

6. A directional tear packaging film process comprising:
coextruding layers in the following sequential order forming a directional tear packaging film: i) a polyamide layer comprising a polyamide in an amount from 5% to 60% by weight of the packaging film, ii) an ethylene vinyl alcohol copolymer blend layer (EVOH blend layer) comprising an ethylene vinyl alcohol copolymer in an amount from 60% to 99% by weight of the EVOH blend layer and a polyethylene in an amount from 1% to 40% by weight of the EVOH blend layer and iii) a sealant layer;
biaxially orienting the directional tear packaging film; and
annealing the directional tear packaging film;
wherein the directional tear packaging film comprises a Shrinkage Value from 0% to 60% in each of the machine direction and the transverse direction when tested according to ASTM D2732 using bath temperature of 90° C.

7. The directional tear packaging film process of claim 6, wherein the directional tear packaging film comprises a Shrinkage Value from 0% to 10% in each of the machine direction and the transverse direction when tested according to ASTM D2732-03 using bath temperature of 90° C.

8. The directional tear packaging film process of claim 7, wherein the directional tear packaging film comprises a Shrinkage Value from 0% to 20% in each of the machine direction and the transverse direction when tested according to ASTM D2732-03 using bath temperature of 90° C.

9. The directional tear packaging film process of claim 8, wherein the steps of coextruding, biaxially orienting and annealing occur in a continuous in-line process.

10. The directional tear packaging film process of claim 9, comprising a triple bubble process.

11. A directional tear packaging film process comprising:
coextruding layers in the following sequential order forming a directional tear packaging film: i) a polyamide layer comprising a polyamide in an amount from 5% to 60% by weight of the packaging film, ii) an ethylene vinyl alcohol copolymer blend layer (EVOH blend layer) comprising an ethylene vinyl alcohol copolymer in an amount from 60% to 99% by weight of the EVOH blend layer and a polyethylene in an amount from 1% to 40% by weight of the EVOH blend layer and iii) a sealant layer; and
biaxially orienting the directional tear packaging film;
wherein the directional tear packaging film comprises a Shrinkage Value from 0% to 60% in each of the machine direction and the transverse direction when tested according to ASTM D2732 using bath temperature of 90° C.
